(19) United States
(12) Patent Application Publication
(10) Pub. No.: US 2015/0183890 A1
(43) Pub. Date: Jul. 2, 2015

(54) Methods for Formation of Cyclodextrin-Ursolic Acid Inclusion Complex

(71) Applicant: Campbell Industries, Mason City, IA (US)

(72) Inventor: Douglass S. Campbell, Mason City, IA (US)

(21) Appl. No.: 14/561,289

(22) Filed: Dec. 5, 2014

Related U.S. Application Data
(60) Provisional application No. 61/912,211, filed on Dec. 5, 2013.

(51) Int. Cl. C08B 37/16; B01D 1/30

(52) U.S. Cl. CPC C08B 37/0015; B01D 1/30

(57) ABSTRACT

A method for making a cyclodextrin-ursolic acid inclusion complex comprising combining a ursolic acid source, a cyclodextrin, and a solvent to form a mixture; evaporating the mixture in an evaporator; evaporating the mixture while applying ultrasonic energy and mechanical agitation to the mixture; and drying the evaporated mixture to form a powder of cyclodextrin-ursolic acid inclusion complex.

### CROSS-REFERENCE TO RELATED APPLICATION(S)

This application claims priority to U.S. Provisional Application No. 61/912,211 filed Dec. 5, 2013, which is incorporated herein by reference in its entirety for all purposes.

### FIELD OF THE INVENTION

The various embodiments disclosed herein relate to methods of producing a cyclodextrin-ursolic acid complex with increased bioavailability and therapeutic utility compared to uncomplexed ursolic acid and related compositions.

### BACKGROUND OF THE INVENTION

Ursolic acid (“UA”) is a pentacyclic triterpenoid that has been the subject of intense research interest over the past two decades. It is present in numerous plants regularly consumed by humans and has been isolated from apples, basil, bilberries, cranberries, elder flower, peppermint, rosemary, lavender, oregano, thyme, hawthorn, and prunes. Interest in UA's therapeutic potential comes from studies showing it possesses anti-inflammatory, anti-cancer, hepatoprotective, and trypanocidal pharmacological properties. However, ursolic acid is a highly hydrophobic compound with poor water solubility. This is thought to result in poor bioavailability and has limited clinical utility of ursolic acid.

Various methods have been used to increase the solubility and stability of drugs, such as the use of organic solvents, emulsions, liposomes and micelles, adjustments of pH and the dielectric constant of the solvent system, chemical modifications, and complexation of the drugs with appropriate complexing agents, e.g. cyclodextrins. Similar approaches have been taken to increase the solubility and stability of food additives, agrochemicals and cosmetic additives.

### BRIEF SUMMARY OF THE INVENTION

While multiple embodiments are disclosed, still other embodiments will become apparent to those skilled in the art from the following detailed description, which shows and describes illustrative embodiments of the invention. As will be realized, the invention is capable of modifications in various obvious aspects, all without departing from the spirit and scope of the various implementations disclosed and contemplated herein. Accordingly, the drawings and detailed description are to be regarded as illustrative in nature and not restrictive.

In one aspect, a method is provided for making a cyclodextrin-ursolic acid inclusion complex comprising combining a ursolic acid source, a cyclodextrin, and a solvent to form a mixture; evaporating the mixture while applying ultrasonic energy and mechanical agitation to the mixture; and drying the evaporated mixture to form a powder of cyclodextrin-ursolic acid inclusion complex. In further aspects, the solvent is an aqueous solvent. In still further aspects, the aqueous solvent is water. In another aspect, the method further comprising a co-solvent. In certain aspects, the co-solvent is ethanol. In certain aspects, the ursolic acid source is selected from a group comprising: sage extract, holy basil extract, dehydrated apple peel, loquat leaf extract, cranberry extract, bilberries, cranberries, elder flower, peppermint, lavender, oregano, thyme, sage, hawthorn, bearberry, or prunes. In further aspects, the ursolic acid source is highly purified ursolic acid. In yet further aspects, the highly purified ursolic acid source is at least 99% pure. In still further aspects, the highly purified ursolic acid source is comprised of ursolic acid at an amount of at least about 97, 97.5, 98, 98.5, 99, 99.5, 99.8 weight percent where the percentages are based on the weight of ursolic acid and on the total weight of the ursolic acid source.

In certain aspects, the cyclodextrin is γ-cyclodextrin. In still further aspects the cyclodextrin is selected from a list consisting of: α-cyclodextrin, β-cyclodextrin, and γ-cyclodextrin. In further aspects, the cyclodextrin is a cyclodextrin derivative. In further aspects, the cyclodextrin derivative is selected from a group consisting of: methyl, propyl, isopropyl, hydroxy methyl, hydroxy ethyl, hydroxy propyl and sulfo alkyl.

In certain embodiments, the ultrasonic energy is supplied at a frequency of about 40 kHz. In further embodiments the evaporator heats the mixture to a temperature of about 80% of the boiling point of the solvent. In further embodiments, the mechanical agitation is supplied by means of an immersable mixer. In yet further embodiments, the mixture is evaporated until the volume of the mixture is reduced by about half of the starting volume of the mixture. In certain aspects, the evaporated mixture is dried until only about 10% moisture remains. In further aspects, the evaporated mixture is dried until less than about 10% moisture remains.

### BRIEF DESCRIPTION OF THE DRAWINGS

FIG. 1 shows the structure of UA in two dimensional (A) and three dimensional (B) renderings.

FIG. 2 shows the structures of α-cyclodextrin (A), β-cyclodextrin (B), γ-cyclodextrin (C) and a 3-dimensional representation of γ-cyclodextrin (D).

FIG. 3 shows a 3-dimensional representation of uncomplexed ursolic acid and cyclodextrin (A) and the cyclodextrin-ursolic acid inclusion complex (B).

FIG. 4 shows a flow chart of the process for formation of cyclodextrin-ursolic acid inclusion complexes according to certain embodiments.

FIG. 5 shows a schematic of the vessel used in the for formation of cyclodextrin-ursolic acid inclusion complexes according to certain embodiments.

FIG. 6 shows a schematic of the vessel and the optimal ultrasonic field according to certain embodiments.

### DETAILED DESCRIPTION

Although the certain preferred embodiments have been described herein, persons skilled in the art will recognize that changes may be made in form and detail without departing from the spirit and scope of the inventions disclosed and contemplated herein. As used herein, the term “cyclodextrin” or “cyclodextrin compound” means a cyclomalto-oligosaccharide having at least five glucopyranose units joined by an α(1-4) linkage. Examples of useful cyclodextrins include α-, β-, or γ-cyclodextrin wherein α-cyclodextrin has six glucose residues; β-cyclodextrin has seven glucose residues, and β-cyclodextrin has eight glucose residues. Cyclodextrin molecules are characterized by a rigid, truncated conical molecular structure having a hollow interior, or pore, of specific volume. “Cyclodextrin” can also include cyclodextrin derivatives as defined below, or a blend of one or more cyclodextrins. The following table recites properties of α-, β-, and γ-cyclodextrin.

Cyclodextrin Properties

| | α-CD | β-CD | γ-CD |
|---|---|---|---|
| Degree of | 6 | 7 | 8 |
| Polymerization | | | |
| (n=) | | | |
| Inside | 5.7 | 7.8 | 9.5 |
| Diameter (A°) | | | |
| Outside | 13.7 | 15.3 | 16.9 |
| Diameter (A°) | | | |
| Height (A°) | 7 | 7 | 7 |
| Specific | 150.5 | 162.5 | 177.4 |
| Rotation | | | |
| [α]²⁵_{D} | | | |
| Color of | Blue | Yellow | Yellowish |
| Iodine | | | Brown |
| Complex | | | |
| Solubility in | 14.5 | 1.85 | 23.2 |
| Distilled | | | |
| Water (g/100 mL) | | | |
| 25° C. | | | |

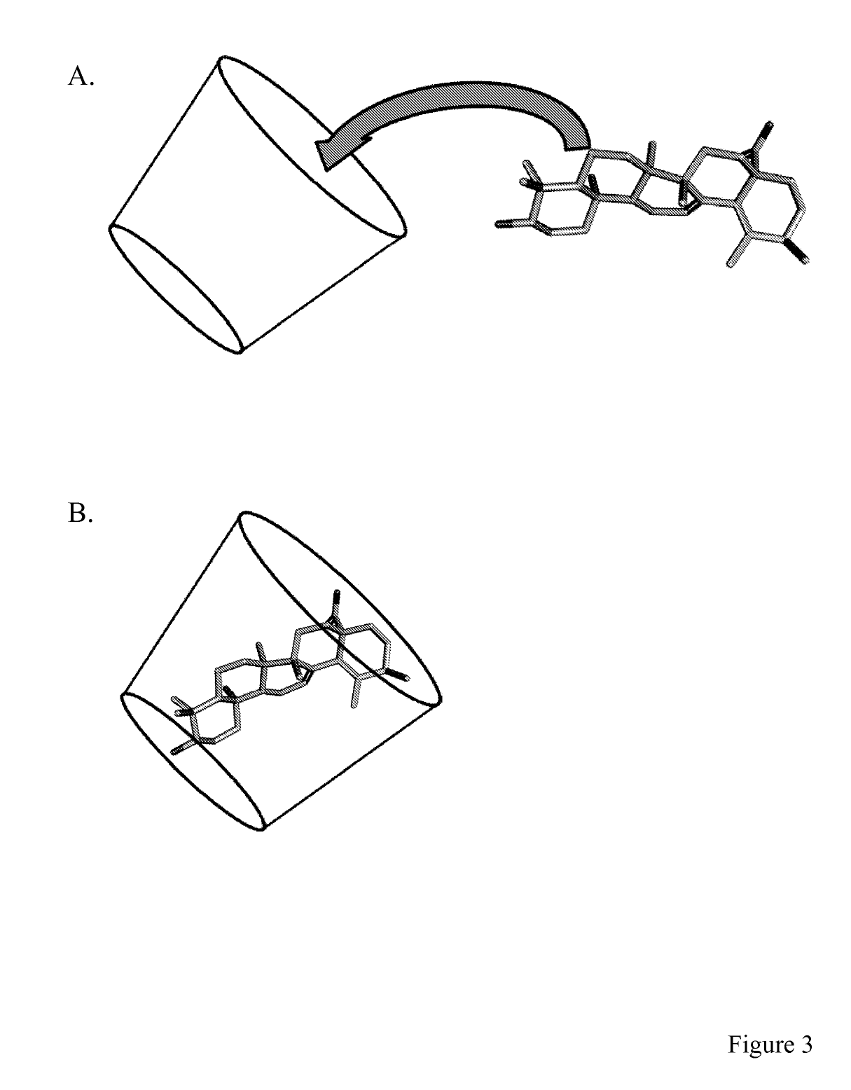

As used herein, the term “cyclodextrin ursolic acid inclusion complex” means the combination of an ursolic acid compound and a cyclodextrin wherein the ursolic acid compound is disposed substantially within the pore of the cyclodextrin ring. A schematic of the complex is shown in FIG. 3. The cyclodextrin inclusion complexes include, inherent to the formation and existence of the inclusion complex, some amount of “uncomplexed” cyclodextrin; this is because (1) in embodiments synthesis of the inclusion complex does not result in 100% formation of inclusion complex; and (2) in embodiments, the inclusion complex is in equilibrium with uncomplexed cyclodextrin/uncomplexed ursolic acid. Each combination of cyclodextrin and ursolic acid has a characteristic equilibrium associated with the cyclodextrin inclusion complex.

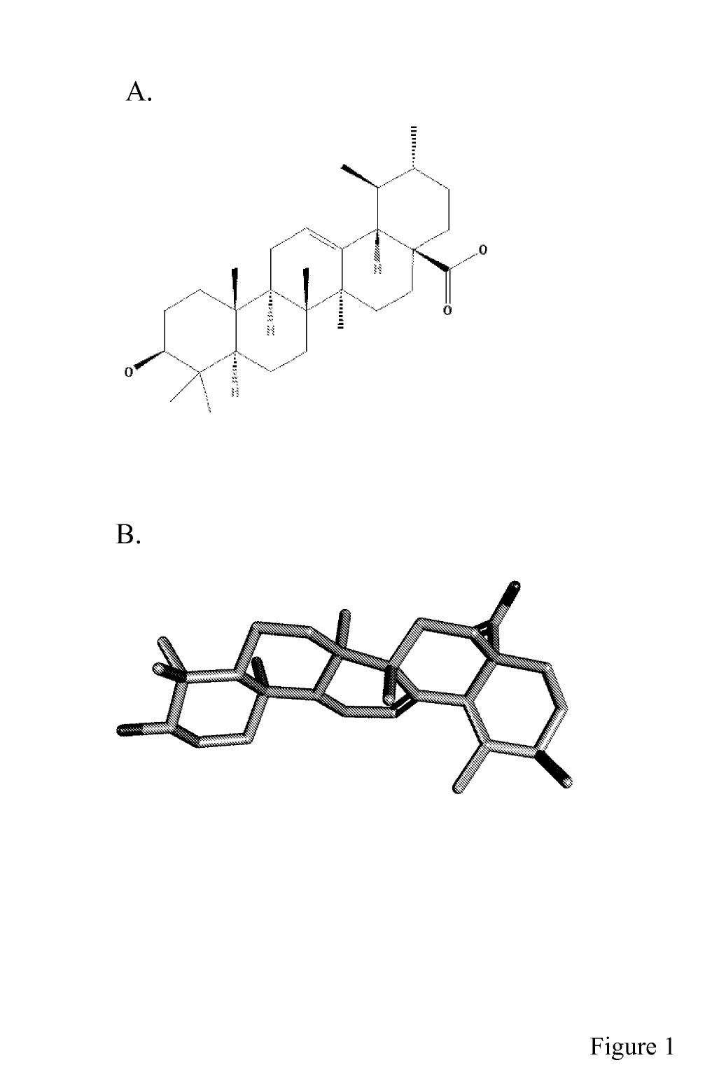

As used herein, “ursolic acid” refers to ursolic acid, or extracts containing ursolic acid from plants such as apples, holy basil, bilberries, cranberries, elder flower, peppermint, lavender, oregano, thyme, sage, hawthorn, bearberry or prunes. Other names for ursolic acid include 3-β-hydroxy-urs-12-en-28-oic acid, urson, prunol, micromerol, urson, and malol. The structure for Ursolic Acid is shown generally in FIG. 1.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

As used herein, the terms “optional” or “optionally” means that the subsequently described event or circumstance can or cannot occur, and that the description includes instances where said event or circumstance occurs and instances where it does not.

As used herein, the term “analog” refers to a compound having a structure derived from the structure of a parent compound (e.g., a compound disclosed herein) and whose structure is sufficiently similar to those disclosed herein and based upon that similarity, would be expected by one skilled in the art to exhibit the same or similar activities and utilities as the claimed compounds, or to induce, as a precursor, the same or similar activities and utilities as the claimed compounds.

As used herein, the term “prevent” or “preventing” refers to precluding, averting, obviating, forestalling, stopping, or hindering something from happening, especially by advance action. It is understood that where reduce, inhibit or prevent are used herein, unless specifically indicated otherwise, the use of the other two words is also expressly disclosed.

The term “contacting” as used herein refers to bringing a disclosed compound and a cell, target receptor, or other biological entity together in such a manner that the compound can affect the activity of the target (e.g., receptor, transcription factor, cell, etc.), either directly; i.e., by interacting with the target itself, or indirectly; i.e., by interacting with another molecule, co-factor, factor, or protein on which the activity of the target is dependent.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc. It is also contemplated that, in certain aspects, unless expressly indicated to the contrary, individual substituents can be further optionally substituted (i.e., further substituted or unsubstituted).

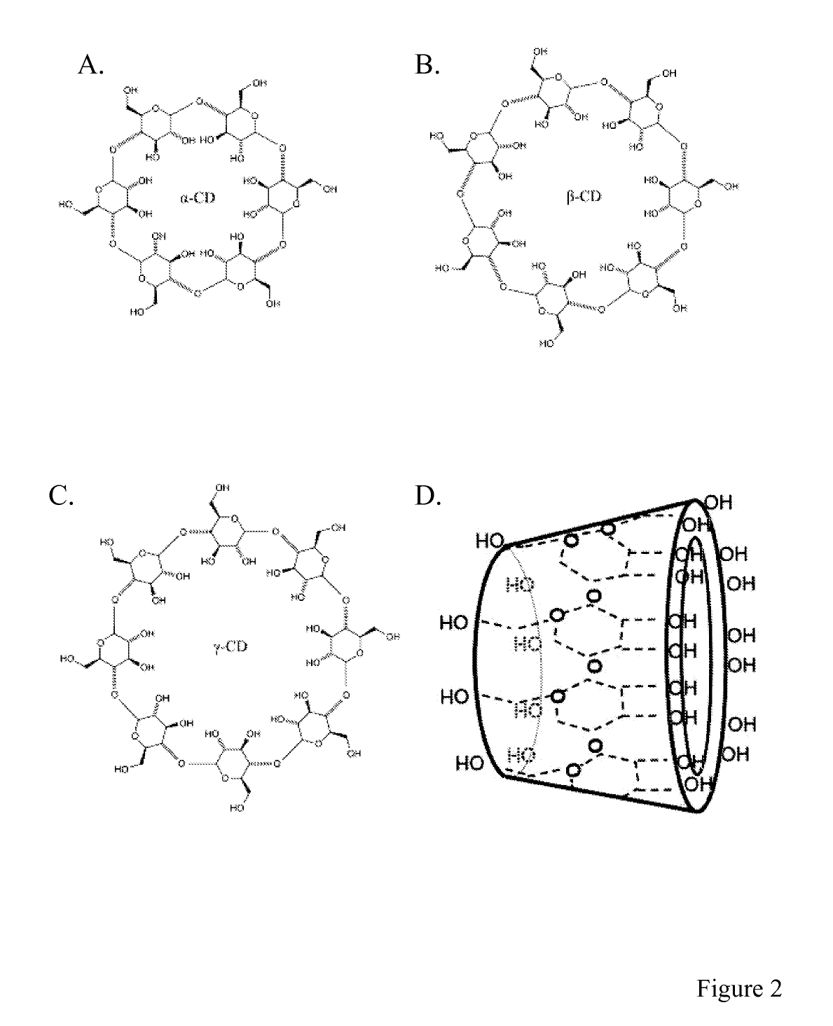

Cyclodextrins are cyclic oligosaccharides with hydroxyl groups on the outer surface and a void cavity in the center. Their outer surface is hydrophilic, and therefore they are usually soluble in water, but the cavity has a lipophilic character. Structures of exemplary cyclodextrins are shown in FIG. 2. The most common cyclodextrins are α-cyclodextrin (FIG. 2A), β-cyclodextrin (FIG. 2B) and γ-cyclodextrin (FIG. 2C), consisting of 6, 7 and 8 α-1,4-linked glucose units, respectively. The number of these units determines the size of the cavity. Cyclodextrins are capable of forming inclusion complexes with a wide variety of hydrophobic molecules by taking up a whole molecule, or some part of it, into the cavity. The stability of the complex formed depends on how well the guest molecule fits into the cyclodextrin cavity. Common cyclodextrin derivatives are formed by alkylation (e.g. methyl- and ethyl-β-cyclodextrin) or hydroxyalkylation of the hydroxyl groups (e.g. hydroxypropyl- and hydroxyethyl-derivatives of α-, β-, and γ-cyclodextrin) or by substituting the primary hydroxyl groups with saccharides (e.g. glucosyl- and maltosyl-β-cyclodextrin).

The formation of cyclodextrin-ursolic acid (CDUA) inclusion complexes may be one approach to increasing the solubility and bioavailability and thus therapeutic utility of ursolic acid. Yet there is a need in the art for a process to efficiently and inexpensively form CDUA without the use of toxic organic solvents that are difficult to remove from the finished product. It is a well know phenomenon that specific chemicals are extracted with solvent from botanical sources with the aid of sonochemistry. The development of cavitations and collapse in an ultrasonic field is conducive to the extraction processes. In the cavitation process, a supercritical environment exists for microseconds. Therefore, supercritical processes may be achieved at STP (standard temperatures and pressures). One method of inducing cavitation is through the use of ultrasonic energy. Ultrasound can induce unusual high-energy chemistry through the process of acoustic cavitation: the formation, growth, and implosive collapse of bubbles in a liquid. Cavitation can occur both in clouds of collapsing bubbles (multi-bubble cavitation, MBC) or with high symmetry for isolated bubble (single-bubble cavitation, SBC). Multi-bubble cavitational collapse produces localized, transient hot spots with intense local heating (˜5000K), high pressures (˜2000 atm), and short lifetimes (sub-microsecond) in an otherwise cold liquid.

According to certain embodiments, disclosed is a method for making a cyclodextrin-ursolic acid inclusion complex comprising a) combining a ursolic acid source, a cyclodextrin, and a solvent to form a mixture; b) evaporating the mixture in an evaporator; c) evaporating the mixture while applying ultrasonic energy and mechanical agitation to the mixture; and d) drying the evaporated mixture to form a powder of cyclodextrin-ursolic acid inclusion complex. In further embodiments, the solvent is an aqueous solvent. In yet further embodiments, the aqueous solvent is water. In still further embodiments, the mixture further comprises a co-solvent. In further embodiments, the co-solvent is ethanol. In certain embodiments, the ursolic acid source is selected from a group consisting of: sage extract, holy basil extract, dehydrated apple peel, loquat leaf extract, cranberry extract, bilberries, cranberries, elder flower, peppermint, lavender, oregano, thyme, sage, hawthorn, bearberry, or prunes. In further embodiments, the ursolic acid source is highly purified ursolic acid. In yet further embodiments, the highly purified ursolic acid source is at least 99% pure. In still further embodiments, the highly purified ursolic acid source is comprised of ursolic acid at an amount of at least about 97, 97.5, 98, 98.5, 99, 99.5, 99.8 weight percent where the percentages are based on the weight of ursolic acid and on the total weight of the ursolic acid source.

In certain embodiments, the cyclodextrin is γ-cyclodextrin. In further embodiments, the method of claim 1 where the cyclodextrin is selected from a list consisting of: α-cyclodextrin, β-cyclodextrin, and γ-cyclodextrin. According to certain embodiments, the cyclodextrin is a cyclodextrin derivative. In certain embodiments, the cyclodextrin derivative is selected from a group consisting of: methyl, propyl, isopropyl, hydroxy methyl, hydroxy ethyl, hydroxy propyl and sulfo alkyl.

In certain embodiments, ultrasonic energy is supplied at a frequency of about 40 kHz. According to further embodiments, the evaporator heats the mixture to a temperature of about 80% of the boiling point of the solvent. In certain embodiments, mechanical agitation is supplied by means of an immersable mixer. In further embodiments, the mixture is evaporated until the volume of the mixture is reduced by about half of the starting volume of the mixture. According to certain embodiments, the evaporated mixture is dried until about 10% moisture remains.

Further disclosed herein is a cyclodextrin-ursolic acid inclusion complex product made according to the process of: a) combining a ursolic acid source, a cyclodextrin, and a solvent to form a mixture; b) evaporating the mixture in an evaporator; c) evaporating the mixture while applying ultrasonic energy and mechanical agitation to the mixture; and d) drying the evaporated mixture to form a powder of cyclodextrin-ursolic acid inclusion complex. According to certain embodiments, the cyclodextrin derivative is selected from a group consisting of: methyl, propyl, isopropyl, hydroxy methyl, hydroxy ethyl, hydroxy propyl and sulfo alkyl.

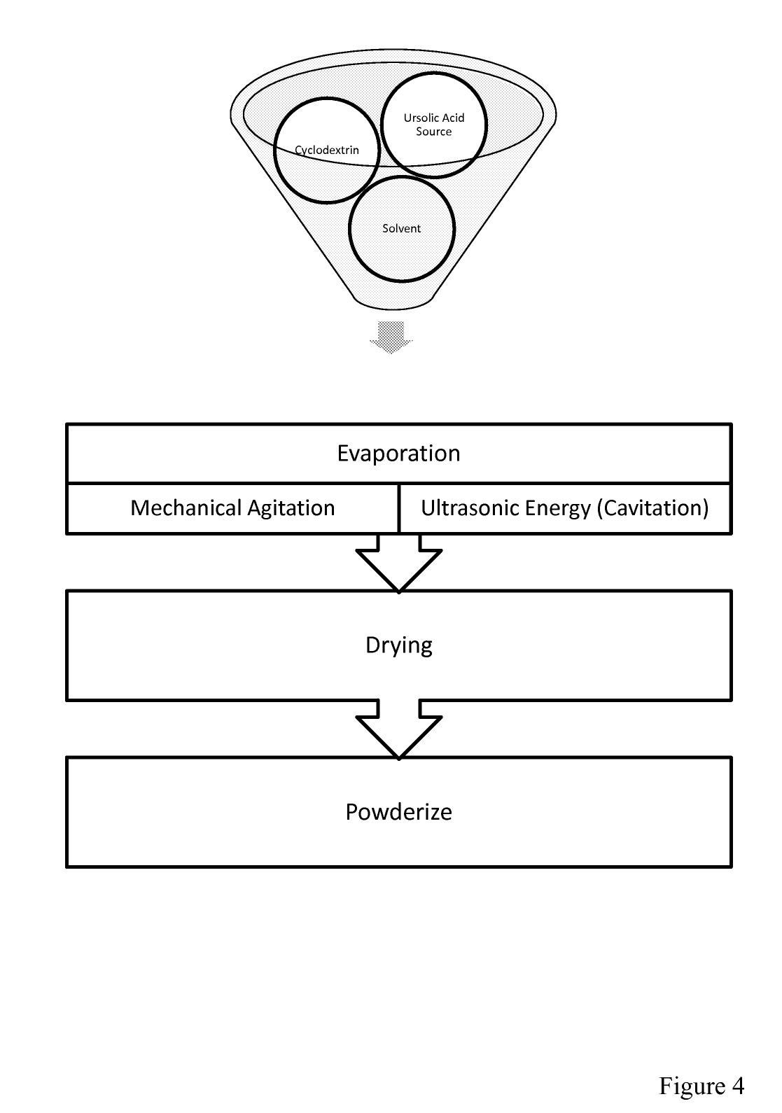

According to certain embodiments, shown generally in FIG. 4, a cyclodextrin inclusion complex can be formed by the following process, which may include some or all of the following steps:
1. Combining a ursolic acid source, cyclodextrin, and a solvent to form a mixture;
2. Evaporating the mixture while providing mechanical agitation and ultrasonic energy to the mixture;
3. Drying the evaporated mixture to form a powder of CD-UA IC;
4. Powderizing the dried mixture, for example, by using a sieve.

In certain embodiments, the UA source of step 1 is a highly purified pharmaceutical grade ursolic acid, for example, a ursolic acid source contain between about 90% and 100% ursolic acid. In further embodiments, the ursolic acid source is comprised of ursolic acid in an amount of at least about 97, 97.5, 98, 98.5, 99, 99.5, 99.8 weight percent where the percentages are based on the weight of ursolic acid and on the total weight of the ursolic acid source.

In still further embodiments, the ursolic acid source is a botanical extract. For example in certain embodiments the ursolic acid source is selected from a group comprising sage extract, holy basil extract, dehydrated apple peel, loquat leaf extract, cranberry extract, bilberries, cranberries, elder flower, peppermint, lavender, oregano, thyme, sage, hawthorn, bearberry, prunes, Rosmarinus officinalis, Glechoma hederaceae, Ilex paraguariensis, Ichnocarpus frutescens, Phoradendron juniperinum, Syzygium claviflorum, or Hyptis capitata. One skilled in the art will recognize that other plant sources of ursolic acid are possible ursolic acid sources suitable for use in the various embodiments disclosed and contemplated herein.

In certain embodiments, the ursolic acid source further comprises at least one other triterpenoid. In still further embodiments, the at least one other triterpenoid is oleanolic acid. In yet further embodiments, the ursolic acid source comprises ursolic acid present in an amount of about 80% and oleanolic acid present in an amount of about 20%.

In certain embodiments the CD is selected from the group of α-, β-, and γ-cyclodextrin. In some further embodiments, the CD is γ-cyclodextrin, for example Cavamax W8, (Wacker Chemie, AG) food grade, molecular weight 1297 grams per mole. In still further embodiments, the CD is a synthetic CD derivative, including but not limited to derivatives of cyclodextrins such as methyl, propyl, isopropyl, hydroxy methyl, hydroxy ethyl, hydroxy propyl and sulfo alkyl. In certain embodiments, the CD will be a combination of two or more of the foregoing or other CDs known to one skilled in the art.

In certain embodiments, the solvent is an aqueous solvent such as water. In still further embodiments, the mixture may further comprise a co-solvent, for example ethanol. In yet further embodiments, the co-solvent is an alcohol, including but not limited to alcohols such as methanol, ethanol, propyl alcohol and isopropyl alcohol. In still further embodiments the co-solvent may comprise ketones that include acetone and methyl ethylketone, ethers such as diethyl ether, dimethyl ether and methylethyl ether, acetates that include ethyl acetate, acids such as acetic acid, anhydrides such as acetic anhydride, chlorinated solvents such as chloroform, dichloromethane and dichloroethane, and hexanes etc. One skilled in the art will recognized that other co-solvents are possible. When more energy is provided to the mixture through heat or ultrasonic energy, it decreases the need for the use of a co-solvent. Conversely, if less heat or ultrasonic energy are used, the more likely it is that a co-solvent will be required for inclusion complex formation.

In certain embodiments, co-solvent may be present at various proportions relative to the solvent. For example, in certain embodiments the co-solvent comprises about 0% to about 95% of the total co-solvent-solvent volume. In still further embodiments, ratio is 80% to 20% solvent to co-solvent and in still further embodiments, the ratio is 30% to 70% solvent to co-solvent. One skilled in the art will appreciate that other ratios are possible.

In certain embodiments, the molar ratio of CD to ursolic acid source can range from about 0.1:10 to about 10:0.1. In certain embodiments the ratio is a molar ratio of about 2:1.

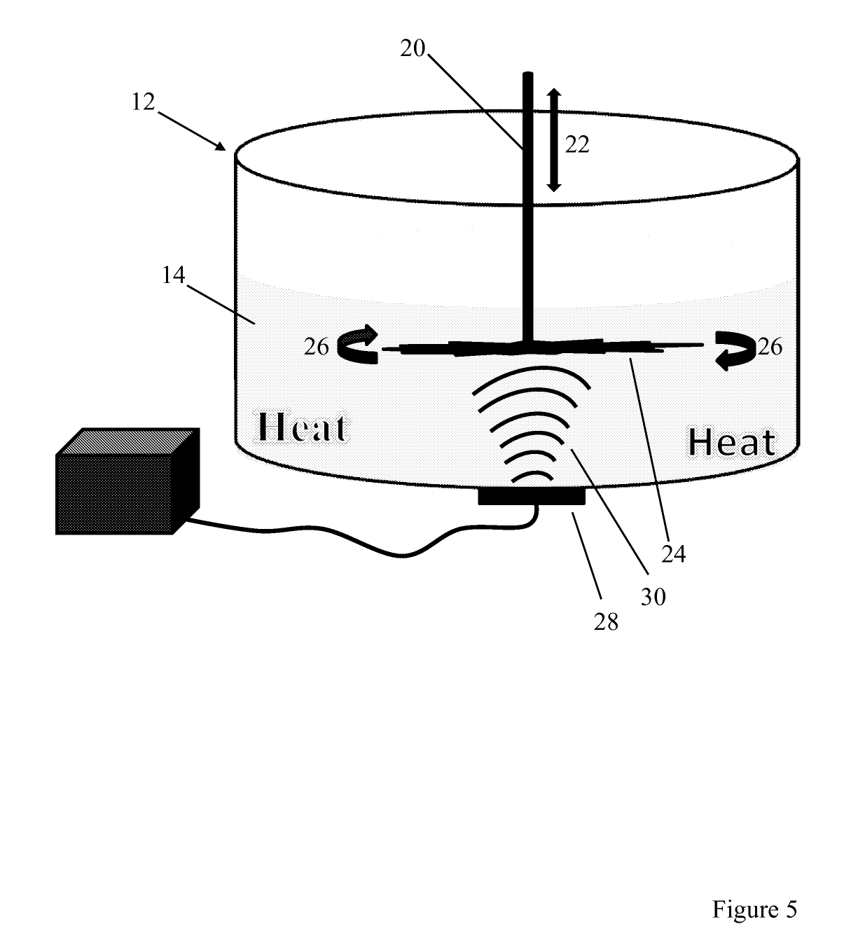

With respect step 2, in certain embodiments the mixture is placed in a vessel. A schematic of a exemplary vessel 12 is shown in FIG. 5. One skilled in the art will realize many vessels are possible. In certain embodiments, the vessel 12 is an evaporator, that is, it provides heat to the mixture to evaporate solvent during the process. In still further embodiments the vessel also provides ultrasound energy 30 to the mixture. For example, the ultrasonic tank from Ultrasonic Power Corporation, 500 watts, having internal tank dimensions of 11×14×11 inches, and providing 40 kHz frequency with a sweep feature of 38 kHz to 42 kHz. In still further embodiments, ultrasonic energy 30 is provided at 20 kHz. In still further embodiments, the frequency of the ultrasonic energy 30 provided is between about 20 kHz and about 42 kHz. According to certain embodiments, the tank provides an electric heater that can heat mixtures to about 250° F. One skilled in the art will realized that the vessel size, heating capacity, and ultrasonic output can be easily scaled for larger or smaller batch sizes as required. In certain embodiments, mixing the components of step 1 can be performed in the vessel.

With respect to step 2, in certain embodiments, evaporating the mixture can be achieved by providing heat to the mixture. In certain embodiments, heat is provided by one or more heaters integrated into the vessel. In further embodiments, heat is provided to the vessel by an exogenous source such as a burner or a jacket heater that wraps the vessel to provide heat. In still further embodiments, heat is provided to the mixture via an in-dwelling heating element, submerged within the mixture. One skilled in the art will recognized that other means of providing heat to the mixture are possible.

In certain embodiments, sufficient heat is provided so as to maintain mixture temperature at 80% of the boiling point of the solvent being used. For example, at standard atmospheric pressure, if the solvent being used is water, sufficient heat is supplied such that the mixture temperature is maintained 176° F., 80° C. In still further embodiments, heat is provided to achieve a mixture temperature of up to, but not exceeding about 210° F., 99° C. One skilled in the art will recognize that a range of temperatures are possible. In certain aspects, the mixture temperature is about room temperature. In further aspects, the mixture temperature is between about 32° F., and about 72° F. It will be recognized that the lower the temperature of the mixture at a given pressure, the longer the time that will be required for inclusion complex formation. One skilled in the art will recognize that a range of temperatures are possible.

In certain embodiments, the mixture is evaporated at standard atmospheric pressure. In further embodiments, the vessel is pressurized and heat is provided such that the mixture temperature is substantially higher than the solvent boiling point at standard atmospheric pressures. In certain embodiments, the time needed for inclusion complex formation is substantially reduced when the mixture is mixed under pressurized conditions.

In certain embodiments, the mixture 14 is evaporated until the mixture has substantially reduced in volume. In still further embodiments, the mixture 14 is evaporated until the mixture volume has reduced by about half of the initial mixture volume. In yet further embodiments, the mixture 14 is evaporated until mixture viscosity has increased substantially.

In certain embodiments, ultrasonic energy 30 is provided by a transducer embedded or integrated within the vessel 12. In further embodiments, the transducer is an immersible transducer 28 configured to operate within mixture conditions and temperatures. In still further embodiments, the ultrasonic energy 30 is provided to the transducer by means of an ultrasonic generator positioned outside of the vessel.

In certain embodiments, the amount of ultrasonic energy provided is sufficient to induce cavitation bubbles within the mixture 14. In still further embodiments, the amount of ultrasonic energy is sufficient to induce the formation of supercritical environment within the mixture and will vary according to the mixture volume, solvent used, and vessel size. According to certain embodiments, ultrasonic energy is provided by vessel-integrated transducer at a frequency of about 40 kHz and a sweep output with adjustable sweep rate of about 30 to about 1000 Hz. In still further embodiments One skilled in the art will recognize that other ultrasonic frequencies and sweep rates are possible.

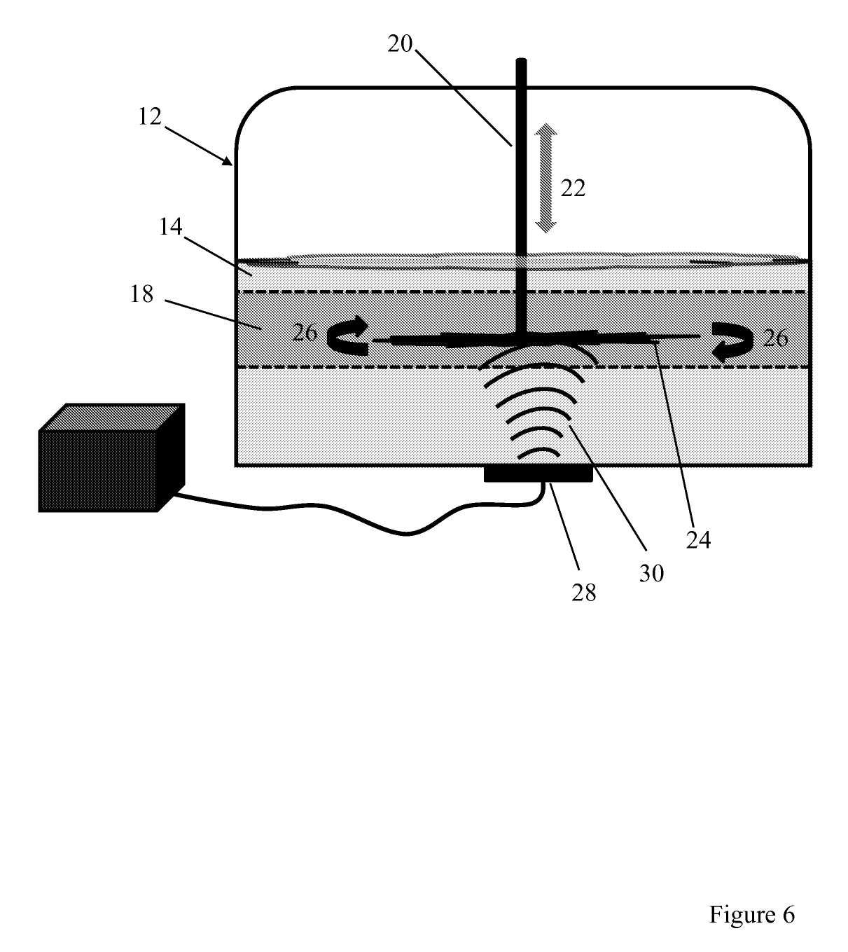

In certain embodiments, as best shown in FIG. 6, the optimal ultrasonic field 18 in the vessel exists in an area about half way between the transducer 28 and the surface of the mixture and this optimal ultrasonic field 18 maximizes inclusion complex formation. According to certain embodiments, agitation is provided to the mixture in order to maximize the flow of the mixture through the optimal ultrasonic field 18. In certain embodiments, agitation is provided by mechanical mixing. In certain exemplary embodiments, mechanical agitation is provided by a submersible mixer 20 that is moved along vertical axis 22 with respect to the mixture 14 while a blade 24 provides radial mixing forces 26. In certain embodiments, the mixer is a paddle mixer. In still further embodiments, agitation is provided by at least one pipe or tube coupled to the vessel, said at least one pipe or tube housing a flow through static mixer. In yet further embodiments, at least one ultrasound transducer is coupled to the at least one pipe or tube such that ultrasonic energy is provided to the mixture as it passes through the at least one flow through static mixer. One skilled in the art will recognize that multiple approaches to provide agitation to the mixture are possible.

With respect to step 3, in certain embodiments the mixture is removed from the vessel for drying. In certain exemplary embodiments, the evaporated mixture is placed on drying sheets and placed in a drying oven. In still further embodiments, the drying step is performed in the vessel such that transfer of the mixture to a separate dryer is unnecessary. Drying intervals require inspection every 1 to 2 hours and may take as long as 8 hours depending on the thickness of the material and the temperature of the drying apparatus range from about 170° F. to about 210° F. As will be appreciated by one skilled in the art, other drying methods are possible, including but not limited to air drying, vacuum drying, spray drying (e.g., with a nozzle spray drier, a spinning disc spray drier, etc.), and combinations thereof.

According to certain embodiments, drying is complete when the final water content of the mixture is below 10% relative humidity at the current atmospheric conditions of barometric pressure and dew point, calculated and determined at the initiation of drying and verified at the conclusion of drying. As will be appreciated by one skilled in the art, other levels of relative humidity are possible and may be desirable depending on the intended downstream applications. In still further embodiments, visual and tactile examination of the material is used to determine adequate drying.

With respect to step 4, in certain embodiments, the mixture forms a flat hard cake during drying. In certain embodiment, the dried mixture is mechanically powderized to form a powder. In further embodiments, the powder is reduced in size until a powder of no greater than ASTM U.S. Sieve number 20, Tyler Screen Scale Equivalent 20, sieve opening millimeters 0.840, inches 0.0331 inches is achieved. In still further embodiments, the powder is a free-flowing powder.

In further embodiments, the CDUA inclusion complex is maintained at temperatures for periods of time that are equal to, or exceed, those of standard pasteurization procedures. In still further embodiments, temperatures equal to, or exceeding, those of standard pasteurization procedures are maintained throughout the CDUA inclusion complex formation process.

In certain embodiments, the process further comprises a formulation step whereby the CDUA inclusion complex is converted into a unit dosage form, e.g. as tablets, capsules, powders, solutions, suspensions, microencapsulation, gel suspensions, such as for example, gellan gel suspensions, emulsions, granules, or suppositories. In such form, the composition is sub-divided in unit dose containing appropriate quantities of the active ingredient; the unit dosage forms can be packaged compositions, for example, packeted powders, vials, ampoules, prefilled syringes or sachets containing liquids. The unit dosage form can be, for example, a capsule or tablet itself, or it can be the appropriate number of any such compositions in package form.

### Example I

At atmospheric pressure, γ-cyclodextrin (Cavamax W8, food grade MW 1297 grams per mole) is combined with sage extract (ursolic acid source) at a molar ration of 2:1 CD:UA. The dry ingredients are combined with equal parts by weight of water (solvent) and mixed in a heavy duty tank (vessel) 14 gauge, 316 L stainless steel double wall construction, with a 60-250° F. (31.5-121.1° C.) adjustable thermostat. The tank is provided with a ultrasonic generator connected via coaxial cable connecting to generator bottom mounted “Vibra-Bar” ultrasonic transducers mounted on the bottom of the tank.

The mixture is heated to 176° F. (80° C.), agitated with a mixer and exposed to ultrasonic energy 40 kHz, sweep +/−2 kHz at a power of 40 watts/liter. The mixer is powered by a 1 HP DC variable speed electric motor and is hoisted using a 316 stainless steel cable and ratchet to allow for raising and lowering of the mixer. One half inch 316 stainless steel shaft of sufficient length to reach from the bottom of the tank to the top operationally pairs to motor and the mixing blade. The mixing blade is 6″ saw tooth blade constructed from 316 stainless steel and designed to mix radially. Mixing speed is controlled by a Baldor variable speed controller to adjust motor up to a maximum of 1825 rpm, the speed at which the mixture is mixed. During mixing, the mixer is up and down along a vertical axis, to provide agitation through the mixture.

CDUA inclusion complex formation is complete when the mixture volume is reduced to about half of the starting volume. The evaporated mixture is then placed on a drying pan and dried at about 200° F. for about 8 hours or until moisture content reaches 10%, whichever is sooner. The dried CDUA inclusion complex is then mechanically powderized until a particle size of no greater than ASTM U.S. Sieve number 20, Tyler Screen Scale Equivalent 20, sieve opening millimeters 0.840, inches 0.0331 inches is achieved.

### Example II

At atmospheric pressure, γ-cyclodextrin (Cavamax W8, food grade MW 1297 grams per mole) is combined with sage extract (ursolic acid source) at a molar ration of 2:1 CD:UA. The dry ingredients are combined with equal parts by weight of water (solvent) and co-solvent ethanol, 30% and 70% respectively. The dry and wet ingredients are mixed in a heavy duty tank (vessel) 14 gauge, 316 L stainless steel double wall construction, with a 60-250° F. (31.5-121.1° C.) adjustable thermostat. The tank is provided with a ultrasonic generator connected via coaxial cable connecting to generator bottom mounted “Vibra-Bar” ultrasonic transducers mounted on the bottom of the tank.

The mixture is heated to 176° F. (80° C.), agitated with a mixer and exposed to ultrasonic energy 40 kHz, sweep +/−2 kHz at a power of 40 watts/liter. The mixer is powered by a 1 HP DC variable speed electric motor and is hoisted using a 316 stainless steel cable and ratchet to allow for raising and lowering of the mixer. One half inch 316 stainless steel shaft of sufficient length to reach from the bottom of the tank to the top operationally pairs to motor and the mixing blade. The mixing blade is 6″ saw tooth blade constructed from 316 stainless steel and designed to mix radially. Mixing speed is controlled by a Baldor variable speed controller to adjust motor up to a maximum of 1825 rpm, the speed at which the mixture is mixed. During mixing, the mixer is up and down along a vertical axis, to provide agitation through the mixture.

CDUA inclusion complex formation is complete when the mixture volume is reduced to about half of the starting volume. The evaporated mixture is then placed on a drying pan and dried at about 200° F. for about 8 hours or until moisture content reaches 10%, whichever is sooner. The dried CDUA inclusion complex is then mechanically powderized until a particle size of no greater than ASTM U.S. Sieve number 20, Tyler Screen Scale Equivalent 20, sieve opening millimeters 0.840, inches 0.0331 inches is achieved.

CDUA made according to the disclosed methods has substantially greater aqueous solubility compared UA alone which is largely insoluble in aqueous solutions. According to certain embodiments, CDUA has a solubility of about 8.6% (w/v) in water.

While various embodiments and examples have been described herein, it is not intended that the inventions be limited to such embodiments or examples. On the contrary, the implementations encompass various alternatives, modifications, and equivalents, as will be appreciated by those of skill in the art.

While specific illustrative embodiments have been described herein, it should be understood that various changes in form and detail may be made without departing from the spirit and scope of the inventions. Therefore, all embodiments that come within the scope and spirit of the inventions, and equivalents thereto, are intended to be claimed. The claims and descriptions should not be read as limited to the described order of elements unless otherwise stated.

What is claimed is:

1. A method for making a cyclodextrin-ursolic acid inclusion complex comprising:
a) combining a ursolic acid source, a cyclodextrin, and a solvent to form a mixture;
b) evaporating the mixture in an evaporator;
c) evaporating the mixture while applying ultrasonic energy and mechanical agitation to the mixture; and
d) drying the evaporated mixture to form a powder of cyclodextrin-ursolic acid inclusion complex.

2. The method of claim 1 wherein the solvent is an aqueous solvent.

3. The method of claim 2 wherein the aqueous solvent is water.

4. The method of claim 1 wherein the mixture further comprises a co-solvent.

5. The method of claim 4 further wherein the co-solvent is ethanol.

6. The method of claim 1 wherein the ursolic acid source is selected from a group comprising: sage extract, holy basil extract, dehydrated apple peel, loquat leaf extract, cranberry extract, bilberries, cranberries, elder flower, peppermint, lavender, oregano, thyme, sage, hawthorn, bearberry, or prunes.

7. The method of claim 1 wherein the ursolic acid source is highly purified ursolic acid.

8. The method of claim 7 wherein the highly purified ursolic acid source is at least 99% pure.

9. The method of claim 7 wherein the highly purified ursolic acid source is comprised of ursolic acid at an amount of at least about 97, 97.5, 98, 98.5, 99, 99.5, 99.8 weight percent where the percentages are based on the weight of ursolic acid and on the total weight of the ursolic acid source.

10. The method of claim 1 where the cyclodextrin is γ-cyclodextrin.

11. The method of claim 1 where the cyclodextrin is selected from a list consisting of: α-cyclodextrin, β-cyclodextrin, and γ-cyclodextrin.

12. The method of claim 1 where the cyclodextrin is a cyclodextrin derivative.

13. The method of claim 12 wherein the cyclodextrin derivative is selected from a group consisting of: methyl, propyl, isopropyl, hydroxy methyl, hydroxy ethyl, hydroxy propyl and sulfo alkyl.

14. The method of claim 1 wherein ultrasonic energy is supplied at a frequency of about 40 kHz.

15. The method of claim 1 wherein the evaporator heats the mixture to a temperature of about 80% of the boiling point of the solvent.

16. The method of claim 1 wherein the mechanical agitation is supplied by means of an immersable mixer.

17. The method of claim 1 wherein the mixture is evaporated until the volume of the mixture is reduced by about half of the starting volume of the mixture.

18. The method of claim 1 wherein the evaporated mixture is dried until only about 10% moisture remains.

19. A cyclodextrin-ursolic acid inclusion complex product made according to the process of:
a) combining a ursolic acid source, a cyclodextrin, and a solvent to form a mixture;
b) evaporating the mixture in an evaporator;
c) evaporating the mixture while applying ultrasonic energy and mechanical agitation to the mixture; and
d) drying the evaporated mixture to form a powder of cyclodextrin-ursolic acid inclusion complex.

20. The product of claim 19 wherein the cyclodextrin derivative is selected from a group consisting of: methyl, propyl, isopropyl, hydroxy methyl, hydroxy ethyl, hydroxy propyl and sulfo alkyl.
